(19) United States
(12) Patent Application Publication
(10) Pub. No.: US 2020/0278991 A1
(43) Pub. Date: Sep. 3, 2020

(54) TOPIC BASED AI AUTHORING AND PLAYBACK SYSTEM

(71) Applicants: Marc Aaron Canter, Walnut Creek, CA (US); Stephen Richard DiPaola, North Vancouver (CA); Nazim Mir, Bengaluru (IN)

(72) Inventors: Marc Aaron Canter, Walnut Creek, CA (US); Stephen Richard DiPaola, North Vancouver (CA); Nazim Mir, Bengaluru (IN)

(21) Appl. No.: 16/804,261

(22) Filed: Feb. 28, 2020

Related U.S. Application Data
(60) Provisional application No. 62/811,587, filed on Feb. 28, 2019.

(51) Int. Cl. G06F 16/34; G06F 40/166; G06K 9/62; G06F 16/332; G06F 16/335; G06F 16/33

(52) U.S. Cl. CPC G06F 16/345; G06F 40/166; G06F 16/3334; G06F 16/3328; G06F 16/335; G06K 9/6256

(57) ABSTRACT

Exemplary embodiments of the present disclosure are directed towards a topic based artificial intelligence authoring and playback system, comprising: an interactive personal storytelling proxy system comprising a storytelling proxy authoring module, a storytelling proxy conversation management module, and a timeline module, the storytelling proxy authoring module configured to enable an Instigator to interactively create, train, test, refine and update an untrained state of storytelling proxies on an Instigator's computing device by transferring an interactive content and a media content into the plurality of storytelling proxies, the storytelling proxy conversation management module configured to orchestrate and synchronize different functions, and story structures into comprehensive, optimized interactive content with Interactors, the storytelling proxy authoring module configured to allow the Instigator to share the storytelling proxies with the Interactors from the Instigator's computing device thereby a semantic analysis of the storytelling proxy authoring module allows the storytelling proxies gets smarter through interactions from an Interactor's computing device by Interactors, the timeline module configured to distribute the storytelling proxies publicly on a home timeline after the Instigator satisfied with a trained state of the storytelling proxies.

### CROSS-REFERENCE TO RELATED APPLICATIONS

This patent application claims the benefit of U.S. Provisional Patent Application No. 62/811,587, filed 28 Feb. 2019, entitled “TOPIC BASED AI AUTHORING AND PLAYBACK SYSTEM”, which is incorporated by reference herein in its entirety.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to computer programs configured for interactive communications. More particularly, the present disclosure relates to a system and method that allows for interactively creating, delivering, sharing and distributing interactive content and media through personal storytelling proxies.

### BACKGROUND

Conversational messaging is now the mainstream norm of digital communication with a sender of a message stating their message in the text on the left-hand side and a recipient of the message replying with text on the right-hand side of a message thread. Storytelling proxies are computer programs that conduct “conversations” with an Interactor, such as an end-user, via a messaging interface or via voice activated systems. In a simple example, the storytelling proxy may replace text-based “Frequently Asked Questions (FAQs)” and invite an Interactor to select one of the FAQs. Once a selection is made, in response to such a selection, the Interactor is automatically presented with an answer. Artificial intelligence is deployed through storytelling proxies to parse and understand the language that a human (e.g., the Interactor) types into the storytelling proxy interface, remember key information and to adapt by itself. In another example, the storytelling proxies (created by an author/Instigator), show video clips, images, music, and EFX to the Interactor, who at any point can interrupt the storytelling proxy by typing a question or a statement of their own into the messaging interface of the storytelling proxy, thereby creating a unique hybrid experience [hybrid between the author/Instigator's creation and the Interactor's interaction] that is focused on providing an novel entertainment experience to the Interactor.

Most of today's Chatbots do not implement basic natural language processing but only offer user buttons and interface selectors to interact with the storytelling proxies. The majority of these Chatbots are “intent-based”, in that, an Interactor expects a certain service or product functionality from the Chatbot. For example, the service or product functionality may be an e-commerce transaction, search, booking a table or an airline flight. Some storytelling proxies implement games—but these storytelling proxies simply take existing games (e.g., jeopardy, trivial pursuit, hot or not) and map them into a messaging interface. Some other storytelling proxies distribute news and content, but mainly represent a news channel for existing news and content publications.

Also, generally, today's storytelling proxies sometimes rely on the author of the storytelling proxy to be a programmer or someone skilled in the programming arts, and this limits the reach of the storytelling proxies to a wider section of the society. Currently, the storytelling proxies are not available for entertainment and “crafting” stories to the users. The present invention enables those who are normally not skilled in the programming arts to program/control/manipulate storytelling proxies and their actions so that said storytelling proxies tell stories in such a way as to create an entertainment experience to the Interactor.

Such experience, since it goes beyond “intent-based” interactions, creates a state of disbelief in the mind of the Interactor by attributing a sense of reality to a synthetic storytelling proxy (i.e., making a synthetic being appear as a sentient being).

In the light of aforementioned discussion, there exists a need for a certain system, specifically an authoring/Instigator system comprises compelling conversational storytelling experiences, directory of pre-built and public Beings, a tool for creating and editing a Being, a mechanism for privately sharing Beings with others, with a novel methodology that would overcome the above-mentioned limitations.

### SUMMARY

In an embodiment of the present invention, a system includes an interactive personal storytelling proxy system that is configured to use semantic analysis which provides hierarchical cognitive processing to emulate rich personality based conversations.

An objective of the present disclosure is directed towards providing a solution for authoring and playing back media (e.g., video clips, images, audio, etc.) interlaced with interactive content as artificial intelligence based storytelling proxy.

Another objective of the present disclosure is directed towards enhancing interplay with the inclusion of scripted media (video clips, images, audio etc.) and a semi-autonomous storytelling proxy.

Another objective of the present disclosure is directed towards providing a mechanism for Instigators/authors to prune out hateful or unwanted influences that have been input into the psyche of the public storytelling proxies.

Another objective of the present disclosure is directed towards enabling an Instigator, such as a storytelling proxy creator, to train a storytelling proxy, for the storytelling proxy to transform into a personal storytelling proxy. A part of such training involves the Instigator to define the script of the storytelling proxy, the story script and the media content are combined and tested out. The design of the storytelling proxy is then iterated, refined and grown until the Instigator is satisfied with the design. The combination of the topic and context management module extract meta-data information (topics) from the media content the Instigators input into the storytelling proxy.

Another objective of the present disclosure is directed towards crafting a script by the Instigator to tell a story and enhancing that story by building in text and media responses that provide interactive possibilities in the narrative.

Another objective of the present disclosure is directed towards building a script which is made up of the storytelling proxy's text, media playback and special effects as in motion picture (EFX) and then privately sharing that storytelling proxy with a friend, family member or colleague.

Another objective of the present disclosure is directed towards creating fictional content that engages with an Interactor, including for example, by recording video selfies and displaying images or playing back audio. The process of creating fictional content may include crafting and refining stories together, interviewing, stating opinions and recommendations, retelling stories on important people, places, recollecting things and milestone events and expressing creative ideas and other forms of “non-factual data.”

Another objective of the present disclosure is to enable Instigators and Interactors to create and interact with storytelling proxies that are creatable and intractable without any prior programming language or coding experience, i.e., to enable such creations and interactions to be performed by non-skilled persons in the computer arts to produce exemplary authoring systems. Instigators are uniquely allowed to create and interact with the content in a simultaneous fashion, e.g., by extracting metadata and topics, from video selfies or image recognition, etc.

Another objective of the present disclosure is directed towards enabling the content and conversational feature of the storytelling proxy to be influenced by Interactors.

Another objective of the present disclosure is directed towards utilizing machine-learning artificial intelligence techniques to make personal storytelling proxies smarter over time.

Another objective of the present disclosure is directed towards enabling the Interactors to participate in messaging conversations by uploading or contributing video, audio, and interacting with embedded user interfaces in the conversation.

Another objective of the present disclosure is directed towards enabling the storytelling proxy to continuously learn by taking input from the responses and interaction of Interactor's and feeding that data unto itself to create a recursive learning loop.

According to an exemplary aspect, the topic based artificial intelligence authoring and playback system a storytelling proxy authoring module, a storytelling proxy conversation management module, and a timeline module.

According to another exemplary aspect, the storytelling proxy authoring module configured to enable an Instigator to interactively create, train, test, refine and update an untrained state of a plurality of storytelling proxies on an Instigator's computing device by combining an interactive content and a media content into the plurality of storytelling proxies until the Instigator satisfied with a trained state of the plurality of storytelling proxies.

According to another exemplary aspect, the storytelling proxy authoring module is configured to allow the Instigator on the Instigator's computing device to share the plurality of storytelling proxies with the plurality of Interactors and then the plurality of Interactors immediately gains access to the updated storytelling proxies.

According to another exemplary aspect, the timeline module is configured to allow the Instigator to push the plurality of storytelling proxies publicly on a home timeline.

### BRIEF DESCRIPTION OF THE DRAWINGS

FIG. 1A is a block diagram representing an example environment in which aspects of the present disclosure can be implemented.

FIG. 1B is a block diagram depicting an interactive personal storytelling proxy system 102 shown in FIG. 1A.

FIG. 1C is a diagram depicting the storytelling proxy conversation management module 118 shown in FIG. 1B, in accordance with one or more exemplary embodiments.

FIG. 2A is a diagram depicting a storytelling proxy's home timeline screen, in one or more exemplary embodiments.

FIG. 2B is a diagram depicting a storytelling proxy's life screen, in accordance with one or more embodiments.

FIG. 2C is a diagram depicting a storytelling proxy's leader board screen, in accordance with one or more exemplary embodiments.

FIG. 2D is a diagram depicting a storytelling proxy's knock knock joke screen, in accordance with one or more exemplary embodiments.

FIG. 2E is a diagram depicting a storytelling proxy's gossip screen, in accordance with one or more exemplary embodiments.

FIG. 2F is a diagram depicting let's go out screen, in accordance with one or more exemplary embodiments.

FIG. 3A-FIG. 3B are example diagrams depicting an amalgam of conversational storytelling, memes, and interactive entertainment screens, in accordance with one or more exemplary embodiments.

FIG. 3C is a diagram depicting a script editor screen, in one or more exemplary embodiments.

FIG. 3D is an example diagram depicting the multi-media chat messaging screen, in accordance with one or more exemplary embodiments.

FIG. 4 is a flow diagram depicting a method for training the storytelling proxy to share on the public domain timeline, in one or more exemplary embodiments.

FIG. 5 is a flow diagram depicting a method for improving storytelling script of the storytelling proxy, in one or more exemplary embodiments.

FIG. 6 is a flow diagram depicting a method for developing and sharing storytelling proxy by the Instigators, in one or more exemplary embodiments.

FIG. 7 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

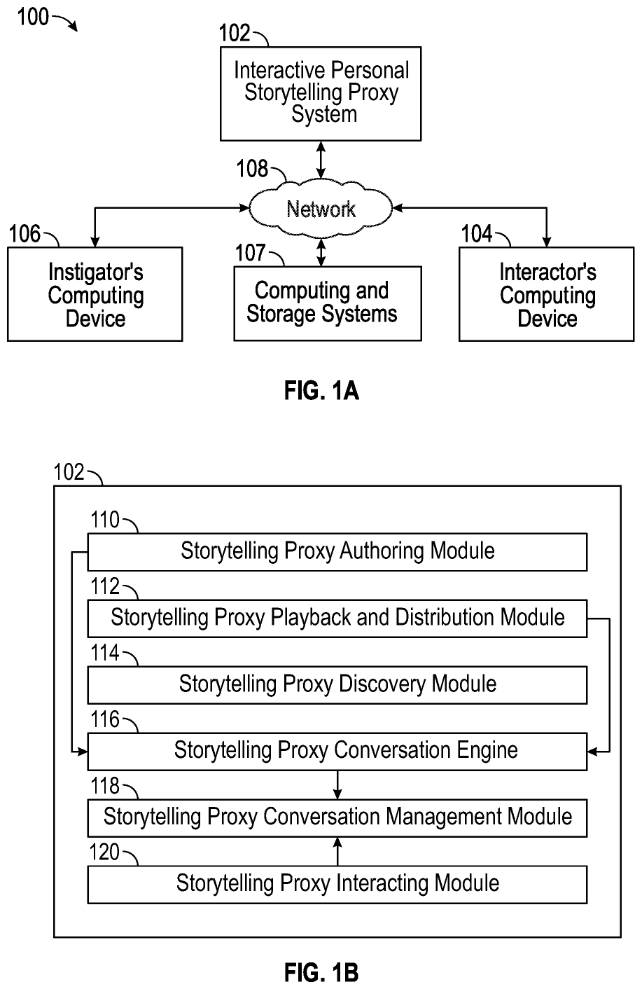

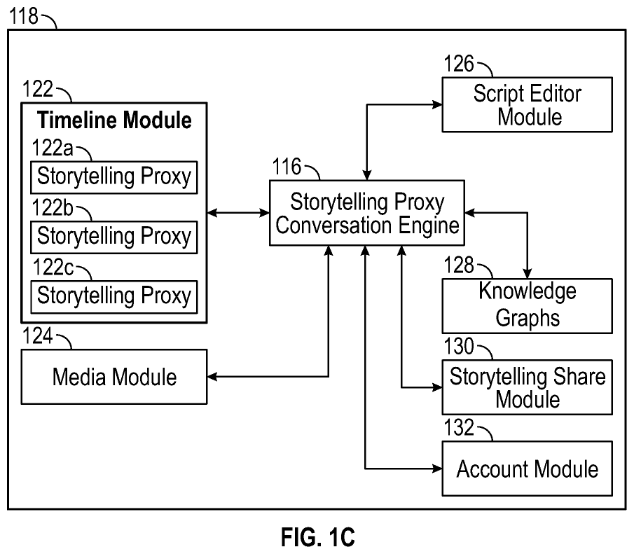

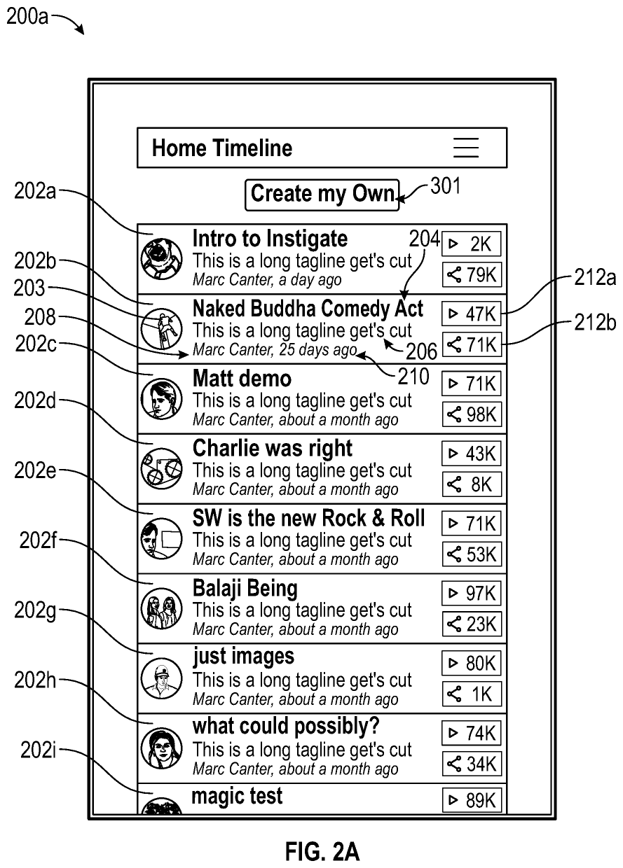

Referring to FIG. 1A, FIG. 1A is a block diagram 100 representing an example environment in which aspects of the present disclosure can be implemented. Specifically, FIG. 1A depicts a schematic representation of system 100 for creating, delivering, sharing and distributing content through storytelling proxies according to an embodiment of the present invention. The system comprises compelling conversational storytelling experiences, directory of pre-built and public storytelling proxies, a tool for creating and editing a storytelling proxy, a mechanism for privately sharing storytelling proxy with others. FIG. 1A depicts an interactive personal storytelling proxy system 102, an Interactor's computing device 104, an Instigator's computing device 106 and a network 108. Each of the devices 104-106 represents a system such as a personal computer, workstation, mobile station, mobile phones, computing tablets, etc. When devices 104-106 correspond to mobile devices (e.g., mobile phones, tablets etc.), and the applications (e.g., interactive personal storytelling proxy system 102) accessed are mobile applications, software that offers the functionality of accessing mobile applications, and viewing/processing of interactive pages, for example, is implemented in the devices 104-106, as will be apparent to one skilled in the relevant arts by reading the disclosure provided herein. Network 108 may include, but is not limited to, an ethernet, a wireless local area network (WLAN), or a wide area network (WAN), a WiFi communication network e.g., the wireless high-speed internet, or a combination of networks. Network 108a-108b may provide for transmission of data and/or information via a control protocol, hypertext transfer protocol, simple object access protocol or any other internet communication protocol. In one or more embodiments, the Interactor may subscribe to the interactive personal storytelling proxy system 102 by signing up, providing profile details and paying subscriptions in the Interactor's computing device 104.

The systems of FIG. 1A may be implemented in a traditional client-server setup or on a cloud setup. Cloud represents a conglomeration of computing and storage systems, in combination with associated infrastructure (including networking/communication technologies, resource management/allocation technologies, etc.) such that the available computing, storage, and communication resources are potentially dynamically allocated to processing of various requests from client systems (e.g., 104-106). Should the systems of FIG. 1A be implemented as shown, while the systems are shown with three components merely for conciseness, it will be readily appreciated that when implemented on a cloud, the systems of FIG. 1A may contain many more servers/systems, mobile devices, potentially in the order of thousands. The computing and storage systems 107 may also be coupled based on IP protocol, though the corresponding connectivity is not shown in FIG. 1A.

The interactive personal storytelling proxy system 102 has four modes of operation such as a conversation mode, an authoring mode, an edit mode, and a share mode. In the conversation mode, the users (for example, the Instigators, and the Interactors) interact with storytelling proxies (and associated story media files) in a messaging interface. The conversation mode is when the user (regardless of whether they are the Instigator OR Interactor) is on the Home timeline. The Instigator and Interactor are browsing and discovering pre-built and public storytelling proxies. Once they tap on any specific storytelling proxy—they are sent into the authoring mode. The authoring mode where the users are turned into authors to train their storytelling proxies and input/define media-based stories. Each storytelling proxy has a current episode which is what is interacted with in the multimedia conversation with the user. Episodes have district openers and endings which provide narrative structure to an episode. Previous Episodes may be available to any Interactor via each storytelling proxy's Archive. In the authoring mode, where an Instigator tests their storytelling proxy or where the Interactor interacts with the storytelling proxy. Both of these scenarios are referred to as “conversational storytelling experiences.” In the edit mode, when the “pencil” is tapped on or the Instigator goes into “Edit mode.” The currently loaded storytelling proxy's script is then displayed in the script editor. Instigators may add, change, and delete the recorded script elements while in the script editor. An insertion menu may be accessed (via tapping on the “+” sign) and an Insertion menu is displayed—allowing Instigators to insert either: Media (Uploaded images or video, recorded images or video), Narration/Text (typed or recorded audio text statements), Whitelist (list of keywords and action associated with them), Background—Background audio, Magic EFX—combination of a video+whitelist, Language Tricks—Knock, knock, Let's go out, Media Menu templates. In the share mode, a share screen may be displayed when the Instigator wishes to share their storytelling proxy, where the Interactors (sharee's) email and name may be specified.

Each storytelling proxy may include an episode of stories and that episode of stories have distinct openers and endings and may be available in an archive.

The interactive personal storytelling proxy system 102 includes autonomous background agents which walk Instigators through all the stages of user experience (UX) user interfaces (UI) screens and input fields necessary to use the interactive personal storytelling proxy system 102. The Instigator may be able to select the agents on the Instigator's computing device 104 and run them of their control on higher “levels” of the interactive personal storytelling proxy system 102. The on boarding process starts with an “intro agent” which provides a controlled environment to nascent beginning Instigators. Later agents include encapsulated experiences to import a story on social networking service (Instagram story), create a backstory item, and utilize video selfies in new ways and help. The interactive personal storytelling proxy system 102 includes artificial intelligence based ‘wrapper” layer configured to provide notification, tutorial, and Intro videos.

Referring to FIG. 1B, FIG. 1B is a block diagram depicting the interactive personal storytelling proxy system 102 shown in FIG. 1A. The interactive personal storytelling proxy system 102 includes a storytelling proxy authoring module 110, a storytelling proxy playback and distribution module 112, a storytelling proxy discovery module 114, a storytelling proxy conversation engine 116, a storytelling proxy conversation management module 118, and a storytelling proxy interacting module 120.

The storytelling proxy authoring module 110 may be configured for interactively creating, configuring, and training, testing, refining and updating the personal storytelling proxy. The Instigators may pro-actively create topics based on the notion that the Instigators may transfer personal knowledge, stories, preferences, videos, photos, history and opinions into the brain of a sentient storytelling proxy embedded inside the interactive personal storytelling proxy system 102, which acts as a proxy for the Instigators. An Instigator, for instance, is an author who creates topics that build a backstory (i.e., a background) and a knowledge base for a storytelling proxy, in order to provide for various levels of interactivity with an Interactor, i.e., an end-user. ‘Topics’ are an authoring paradigm that is a simple enough notion that most intelligent people should be able to understand. Topics are a concept that enables creators to script, manipulate or otherwise “explain” concepts that can then be utilized for interactive narratives or communication. The interactive personal storytelling proxy system 102 may include a My storytelling proxy screen, which may enable the Interactor to become an Instigator by creating their storytelling proxy, keeping track of existing storytelling proxies or share the storytelling proxies with other Interactors. My storytelling proxy screen is where an Instigator creates a new storytelling proxy and lists all of the bots that they have previously created. For example, MyBeings screen options may include, but not limited to, name of being, domain area, appearance and the like. The interactive personal storytelling proxy system 102 provides options like training settings, share beings, and navigate to author the storytelling proxy along with My storytelling proxy screen. The training settings may include, but not limited to, video transcription adjustment, create backstories (e.g., long-form stories or short-form stories) define which question and answers, and create content, and the like. For example, the long-form story may take five minutes or more to tell and make a message. The short-form story may include simple slide shows of text, videos, images and the like. The short-form story may resemble a slide show or short-form poem. For example, the short-form story may be constructed closely and follow snapchat stories which have been recently copied and mimicked by social media platforms like Instagram, Facebook, Messenger stories, and Twitter, known in the art or implemented in the future.

Progressions” may be utilized to gradually expose and educate the Instigators on the operation, concepts, and usage of the storytelling proxy authoring module 110. The introduction progression serves as an introductory series of sentences and conversations which may expose new Instigators to the fundamental features and capabilities of the interactive personal storytelling proxy system 102. The onboarding introductory progression may be controlled by an “Intro Agent” restricting the user's actions and forcing them to move through the initial functionality in a controlled manner. Later progressions provide user advanced features and tools, more sentence types, pre-built storytelling proxies, advanced navigational controls and more control over their authoring environment in general. Progressions expose the Instigators to an advanced drag-and-drop “Episode editor” which may provide them granular control over all aspects and capabilities of the storytelling proxy's training scripts. Each new progression may be achieved by the Instigator earning enough “points”. With each new progression, the complexity and richness of the authoring environment are increased.

“Sentence based” user interface paradigm may be utilized to greatly ease and simplify the authoring process. Sentences not only serve as an instructional tool, walking the Instigator through stages of recording videos or making menu selections; but Sentences also serve as an incredibly powerful tool in setting the context from which the content is authored. The Instigators may easily move back and forth between utilizing a contextually based sentence to create the storytelling proxy's content and settings and testing out the resultant conversation. A sentence based authoring paradigm enables the Instigator to semantically define the interactivity of the conversational storytelling. The sentence based paradigm is an example of an advanced user interface that is only surfaced (exposed) to Instigators at higher “levels” of the interactive personal storytelling proxy system 102.

The process of creating a storytelling proxy may include three steps, a step of adding elements to the storytelling proxy's script, a step of sharing the storytelling proxy, and a step of pushing the storytelling proxy onto the public timeline. The Instigator's computing device 106 may be configured to allow the Instigator to train the storytelling proxy by inputting topics, backstories, imported Instagram stories via the audio and image recognition. After training, the Instigator may share the storytelling proxy to the Interactor's computing device 104 from the Instigator's computing device 106. The storytelling proxy gets smarter through interaction via the Interactor from the Interactor's computing device 104. The Instigator may then choose to push their storytelling proxy onto the public timeline from the Instigator's computing device 106. The storytelling proxy may be then influenced by the Interactors whom the Instigator does not necessarily know. A video selfie may also be utilized to create an effect referred to as a “Magic EFX”, which enables the Interactor to believe that the storytelling proxy understands what was said on the Instigator's video. Step of creating a video selfie may also include capturing the video's audio track, digitizing the audio track and transcribing with the audio track via standard audio recognition software. Further, step of creating the video selfie may also include dynamically extracting key meta-data and information from the audio transcription of the captured video. The Instigator creating the video may be enabled to view the transcript of their video and select which meta-data should be utilized to represent the “meaning” and content of the video. The specific “comebacks” and “quips” of the captured videos are then associated with each Instigator's video. The Instigator's videos are coupled together to create a “Magic EFX” effect. This effect makes the Interactor to believe that the storytelling proxy knows the meaning of the Instigator's video for inserting the comebacks and quips, which directly flows into the conversation after the display of the Instigator's video. The metadata of each video selfie recorded by the Instigator may be shared with the storytelling proxy conversation engine 116, which constitutes a part of the natural language processing system.

Step of adding elements to the storytelling proxy's script further includes responding questions and answers, which may be referred to as a machine learning technique for training the storytelling proxy. The questions may be configured to capture information from the Interactors, which may be related to, psychological, emotionally driven, historical facts, cultural trivia, sports knowledge or movie, music or actor history. The storytelling proxy authoring module 110 may be configured to enable the storytelling proxy Instigator to respond to a set of questions and answers and further control the nature and structure of their storytelling proxy's knowledge and personality. Every text, question, answer, upload and media recording contributed by the Interactor may also be utilized for training the storytelling proxy. Under the guise of “training” a personal storytelling proxy, the present disclosure enables storytelling proxy authors to tell stories via their storytelling proxies which also include a backstory of the storytelling proxy's supposed life and specific sets of answers captured from domain-specific questions. For example, domain-specific vernacular, language tricks, memory occurrences and a wide range of scripted responses and conversational effects are interwoven together with the storytelling proxy's stories and backstory to create the effect of a real-world conversation, as will be described in more detail in the description below.

Step of adding elements to the storytelling proxy's script further includes creating the backstory, also referred to as a storytelling proxy′ life. For example, the backstory items may range from telling a story of an influential teacher or inspirational coach to reminiscing on a particular locket or car. Furthermore, the storytelling proxy may also be configured to utilize the Instigator's backstory in different means for creating the topic. For example, important cities (which have been defined as part of the Storytelling proxy's Backstory) may be “brought up” when the Interactor replies that Chicago is THEIR favorite city “Hey! I love Chi-town too!”.

It is pertinent to note that one of the unique objectives and advantages of the present disclosure is the ability of the Instigator to perform all of their authoring tasks simultaneously. That is, the process of creating a topic for the storytelling proxy that includes, creating video selfies (including the “Magic EFX”), media playbacks, responding to questions and answers, creating backstories, NLP processing (including transitions and domain knowledge parameters included in storytelling proxy conversation management module 118), etc., may all be implemented simultaneously.

The process of creating a backstory by the Instigators for the personal storytelling proxies may be utilized as one of the means for directly defining the history, knowledge, and insights of what the personal storytelling proxies can possess. The created backstory items may be provided as an input to the storytelling proxy conversation engine 116. The storytelling proxy playback and distribution module 112 may be configured to enable the Instigators to produce pseudo sentient storytelling proxies which are then configured to interact with the Interactors. The storytelling proxy discovery module 114 may be configured to discover the storytelling proxies. For example, the Interactors may browse and try out various different personal storytelling proxies from the individual Instigators to brands and celebrities. The storytelling proxy conversation engine 116 is a matrix of real-time language retrieval and dynamic generation engine that may collectively create the effect of narrow natural language processing. The narrow natural language processing may be optimized around the language and vernacular of a particular domain and relies upon pre-built and dynamic language (for example, sentences, phrases) that are directly associated with the specific domain.

The interactive personal storytelling proxy system 102 may be based upon several kinds of databases of knowledge and content that is specifically engineered to drive the narrow natural language processing. The content in the databases may be divided between the fictional conversational language content and dynamically constructed content. The databases may be made up of a language culled from comic books, novelettes or even magazines and newspapers. For example, the pre-built databases may also be constructed by scraping video-sharing platform videos, and capturing the language of video creators. The language of video creators may describe makeup techniques, gameplay, favourite cars and the like. The fictional content is put into machine readable form before it may be utilized by the interactive personal storytelling proxy system 102. The interactive personal storytelling proxy system 102 may also develop dynamic databases that are contextually and situationally aware of content that may be utilized exactly at the proper place in the conversation. Identifying the meaning and understanding of the conversation may require deep cognitive indexing, analysis and dynamic generation of appropriate responses.

The storytelling proxy conversation management module 118 may be made up of different functions, capabilities, and sub-systems. The storytelling proxy conversation management module 118 may be configured to run on a wide range of delivery platforms. For example, the delivery platforms may include social media platforms or voice activated assistants. The storytelling proxy conversation management module 118 may be configured to orchestrate and synchronize different functions, engines, and story structures into comprehensive, optimized interactive content with Interactors. The storytelling proxy conversation management module 118 may also be configured to swap between the storytelling proxy conversations engines 116 that are available to create the desired effect (narrow natural language processing effect). The storytelling proxy conversation management module 118 may be configured to keep track of the overall language and conversation unfolding between the storytelling proxy and the Interactor. The storytelling proxy conversation management module 118 may also be configured to track the paths or branches of the story, bring the right data and features into the conversation at the right time and prevent any repetition.

The storytelling proxy conversation management module 118 may be configured to keep track of the results of questions and answers and backstory topics authored by the Interactor. The storytelling proxy conversation management module 118 may be configured to provide how the “magic EFX” achieved. The storytelling proxy conversation management module 118 may be further configured to coordinate with media playback files. The media playback files may include, but not limited to, audio, video, and images. The storytelling proxy conversation management module 118 may also be configured to implement various forms of conversational special effects, transitions, and segues.

The combination of a series of storytelling proxy conversation engine 116 and the storytelling proxy interacting module 120 together inside the storytelling proxy conversation management module 118 creates a readily changing and fluid conversational environment where the foreground and background elements come together entertainingly. Storytelling is interrupted with backstory recanting. Language tricks and humor are interlaced with domain knowledge and stories. All interaction, querying, responses and interaction is learned and contributed to the system's “learning”—thus making the storytelling proxy smarter and smarter to what language and media playback successfully “works.”

The interactive personal storytelling proxy system 102 may be configured to use a specific type of artificial intelligence called semantical analysis which gives hierarchical cognitive processing enabling to emulate rich personality-based conversations. The interactive personal storytelling proxy system 102 may be configured to use a hierarchical neural network model, specifically a set of interconnected recurrent neural networks. The recurrent neural network may be a class of neural networks where connections between units form a directed cycle. This creates an internal state of the network which allows it to exhibit dynamic temporal behavior, enabling the recurrent neural networks to be used for time-based or stream-based systems, allowing the storytelling proxy conversation management module 118 to deal with an internal memory, a conversation memory, topic flow and well as other aspects of the conversation storytelling proxy that allow for believable and consistent conversation. Most of the recurrent neural networks may use retrieval based models that utilize a repository of predefined responses, which are based on different heuristics which pick an appropriate response based on the input and context. These recurrent neural networks may not generate new text, but instead, pick a response from a fixed set.

The recurrent neural network models may not rely on pre-defined responses and generate new responses from scratch. The recurrent neural network models use deep learning, a sequence to sequence and unsupervised dialog based corpus based techniques. The recurrent neural network models generate plausible responses from the input which are then judged by the high level recurrent neural network. The high level recurrent neural network may pick the most suitable responses. A personality storytelling proxy is heuristic of several emergent and complex goal states that vary depending on different factors or priorities in the high level recurrent neural network. The factors may have to do with the position of the conversation. For example, beginning, middle or need to get to a perceived goal state, a weight that is growing say to move back to the main topic, time since a quip or joke within the current conversation. Several other factors may produce a meaningful, and a personality has driven conversation.

The interactive personal storytelling proxy system 102 may include subsystems that utilize the recurrent neural network to best understand the input question not strictly from labeled words but from the real cognitive intent which gives a much better match to deeper conversation attributes. The recurrent neural network models may work synergistically with the interactive personal storytelling proxy system 102 which uses different machine learning techniques referred to as reinforcement learning neural network. The reinforcement learning neural network may be an offline training system working through encoding and analysis through local and global memory. The reinforcement learning neural network may be an area of machine learning inspired by cognitive psychology, where the artificial intelligence thinks of actions in an environment to maximize the notion of cumulative reward. The reinforcement learning neural network may have a better sense of shared and past memory and learning from the action it makes.

The reinforcement learning neural network may differ from the standard supervised learning in the correct input or output pairs from a large corpus, which is never presented, nor sub-optimal actions explicitly corrected. The reinforcement learning neural network may be enabled to find a balance between exploration (of uncharted territory) and exploitation (of current knowledge). The reinforcement learning neural network may perform offline constant training, and make more personality and cognitive intent driven connections with the growing content set. In the state of full fruition, the reinforcement learning neural network may be the main part that builds a coherent personality driven storytelling proxy through intent level contentions between backstories, analogies, Magic EFX, generally building an internal cognitive model of the personality driven topic-based conversation. The reinforcement learning neural network may keep working behind the scenes, filling up memory, indexing behavior patterns, expanding semantical and contextual connections and associations, so that the content becomes better.

The reinforcement learning neural network and the recurrent neural networks are configured to work in concert. The recurrent neural network and the reinforcement learning neural network may use keywords, phrases, metadata, dynamically constructed data to generate the content and use updated high level cognitive connections made from the reinforcement learning neural network. These cognitive connections may make the working of the recurrent neural network more contextually and situationally aware, so its best response is applied and utilized at exactly the proper place in the conversation. A gross simplification of said machine learning architecture may include a storytelling proxy learning architecture. In an example, the storytelling proxy learning architecture may include ears of blockhead, the mouth of a blockhead, and the like. The ears of blockhead may be an input to the machine learning processes from authored topics created by storytelling proxy creators as well as the ongoing responses, learned patterns, and preferred answers coming from the on-going conversations. The mouth of the blockhead may be an output of machine learning. The output, which is primarily made up of content responses, as well as on-going questions sent as queries to the storytelling proxy's Interactors. The mouth of blockhead and the ears of blockhead may be connected which is a storytelling proxy's brain. The storytelling proxy's brain may grow and get larger and larger as the storytelling proxy gets smarter. ‘Smarter’ means that the storytelling proxy establishes patterns of behavior that remember what answers and responses it has received from the various content and interactive input controls. The combination of the input, the output, the constant learning and the growing of the storytelling proxy's knowledge base is the foundation of machine learning of the interactive personal storytelling proxy system 102. Additionally, other learning techniques such as deep reinforcement learning (DRL), facial recognition (FR) and gesture recognition (GR) may be utilized in the present disclosure, such terms taking the meaning as ordinarily understood in the art. Specifically, the deep learning, reinforcement learning, and deep reinforcement learning techniques may be used to improve upon the facial recognition and gesture recognition models in the present disclosure.

The interactive personal storytelling proxy system 102 may also be configured to contribute status lists to the Interactors. The status list includes a mind map command and a memory command. The mind map command may bring up the current status of storytelling proxy's conversation which is showing the current topic being discussed and the length of the conversation. The memory command may bring up the current content of the storytelling proxy's brain. The current topics of the storytelling proxy's brain may include the responses given and the current state of the topics line. Outside the conversation, it may include wrapper technologies that make up the remaining aspects of the Interactor's usage experience. The Interactor or Instigator may create their own storytelling proxy or simply interact with other's storytelling proxies.

Referring to FIG. 1C, FIG. 1C is a diagram depicting the storytelling proxy conversation management module 118 shown in FIG. 1B, in accordance with one or more exemplary embodiments. The storytelling proxy conversation management module 118 includes a timeline module 122, a media module 124, the storytelling proxy conversation engine 116, a script editor module 126, knowledge graphs 128, a storytelling proxy share module 130, and an account module 132.

The timeline module 122 may be configured to display directory of the storytelling proxies 122a, 122b, and 122c. The timeline module 122 may be configured to display the storytelling proxies 122a, 122b, 122c, sorted and filtered by: last updated, most popular (# of plays), most popular (# of followers), alphabetical (title), Instigator's name, Instigator's region of origin, size and any keyword. As storytelling proxies 122a, 122b, 122c are updated and improved, each storytelling proxy 122a or 122b or 122c follower may get a notification informing them of the update. These notifications may be muted and routed to various on-line accounts and services.

The directory of storytelling proxies 122a, 122b, 122c may include, but not limited to, pre-built celebrity and brand storytelling proxies, alongside user generated storytelling proxies, tutorial storytelling proxies, example storytelling proxies, and so forth. The celebrity and brand storytelling proxies 122a, 122b, 122c which have been paid for and constitute the business model under which the Instigator can operate a profitable business. These storytelling proxies are like any other storytelling proxy, in that a scripted conversation is combined with media and interactive features to create a unique, compelling conversational media experience. Example storytelling proxies 122a, 122b, and 122c available on the home timeline may be designed to excite and recruit new Instigators to the platform by showing off the incredible media storytelling and interactive narrative capabilities of Instigator. These example storytelling proxies 122a, 122b, 122c may demonstrate many of the different various ways to use Instigate's interactive media authoring capabilities. Any element that makes up an Example storytelling proxy's script can be copied and pasted into an Instigator's own storytelling proxy script.

Showcase storytelling proxies 122a, 122b, 122c are exemplary storytelling proxies that have been selected as the best storytelling proxies made by the Instigators. Instigate may be constantly be curating, selecting and highlighting our community of storytelling proxies best work. Any element inside these showcase storytelling proxies may be copied from, but not necessarily have to be made available. The Instigators have full control over who can copy their storytelling proxies elements. The tutorial storytelling proxies 122a, 122b, 122c are storytelling proxies that have been specifically designed to help the Instigators learn how to use the instigate script editor.

Tutorial storytelling proxies 122a, 122b, 122c are storytelling proxies that have been specifically designed to help the Instigators learn how to use the instigate script editor. Various production techniques, storytelling motifs, interactive narrative designs may all be covered by tutorial storytelling proxies 122a, 122b, 122c. Public storytelling proxies 122a, 122b, 122c are pushed public by the storytelling proxy's Instigator for others viewing and interacting with them. The tutorial storytelling proxies 122a, 122b, 122c may reside directly next to celeb or brand storytelling proxies and be fully integrated into instigate home timeline. Instigators fully own their storytelling proxies. By uploading media, creating stories and crafting interactive conversational storytelling proxies. Each Instigator gives us the license and rights to playback and displays the Instigator's content. If the Instigator wishes to leave the storytelling proxy conversation management module 118 and take creative work with them, the copyright and ownership of that content stay with the Instigator.

The timeline module 122 may be executable by a processor to receive one or more storytelling proxies for one or more designated timelines. The media module 124 may be configured to present media files in accordance with the media files on the Instigator's computing device 106 and/or the Interactor's computing device 104. The storytelling proxy conversation engine 116 may be configured to provide an artificial intelligence technique of artificially generating text paragraphs or conversations based upon a pre-defined corpus of content. In the storytelling proxy conversation engine 116, that corpus of data is the storytelling proxy's knowledge graph. The Instigators may be able to insert generative storytelling into a storytelling proxy's script, just as they can insert photos or videos.

Every storytelling proxy 122a or 122b or 122c in the storytelling proxy conversation management module 118 has an associated knowledge graph 128 of content, metadata, relationships, and semantics. The knowledge graph 128 is a database of knowledge and meaning associated with a unique storytelling proxy. The storytelling proxy's Knowledge Graph may be a collection of semantically encoded media, text, ideas and “information” that can be associated with other media and text to create the “illusion” of the storytelling proxy 122a or 122b or 122c “being alive.”

The script editor module 126 is a creator editor (for example, WYSIWYG Creator editor) designed to create, edit and update storytelling proxy scripts. Every storytelling proxy 122a or 122b or 122c has an associated script that controls all of the details, aspects and characteristics of a storytelling proxy's conversational experience. Those details may be defined by the storytelling proxy's script and created and edited in the script editor. The script may be made up of script elements, typed by media, narration/text, and background, magic EFX, language trick. also, a “special script element” called a whitelist may also be inserted into the storytelling proxy's script. The Instigators “insert” script elements into the script and edit them (cut, copy, paste, recorder, delete) within the vertical framework. The storytelling proxy's conversation starts “at the top” and progresses downwards, with each element encapsulating its timing and playback length. Instigators design interactive stories, which combine text and media elements with various kinds of interactive engagement. The Instigators may take a proactive approach, reciting a story, driving the flow until the end of the story. But a counter-reactive approach may also be taken, whereas the storytelling proxy may be designed to answer questions, be a friend, act as a passive tour guide or journey partner as a media and text-based landscape is wrapped around them. Script elements each have tiles associated with them which may be “opened” up (via the three-dot “overflow menu”) to display meta-data or attributes and/or change the content of that element. All element editing has been normalized across all the element types—so tapping once means playback or display, while double tapping means “open up and edit/change.

The storytelling proxy share module 130 may be configured to enable the Instigator on the Instigator's computing device 106 to send an invite to the end-user to become a sharee (Interactor) of that storytelling proxy 122a or 122b or 122c. Once the Interactor has received the storytelling proxy on the Interactor's computing device 104 they can view and interact with that storytelling proxy inside the storytelling proxy's conversation. This interactive media experience may be facilitated by a stand-alone storytelling proxy “player” that works directly on the Interactor's computing device 104.

Since storytelling proxies 122a or 122b or 122c can be updated and edited at any time every Interactor of that storytelling proxy 122a or 122b or 122c may immediately gain access to the updated, improved version of the storytelling proxy 122a or 122b or 122c on the Interactor's computing device 104. Notifications may alert each storytelling proxy's Interactor as to the update and change. The Instigator's aspirational journey concludes when they push their (previously private) storytelling proxy 122a or 122b or 122c out onto the public Home Timeline. This “bird leaving the nest” moment is hard for many parents, but a necessary one in the storytelling proxy's own life journey.

The account module 132 may be configured to enable the Instigator to view the list of storytelling proxies that they have created. That list of storytelling proxies may be called the “My beings” list. Tapping on the storytelling proxy's tile on the Instigator's computing device 106 may send the Instigator into that storytelling proxy's conversation. Double tapping on the storytelling proxy's tile on the Instigator's computing device 106 may send the Instigator into edit mode of that storytelling proxy's script.

Every storytelling proxy 122a or 122b or 122c in the storytelling proxy conversation management module 118 has an associated knowledge graph 128 of content, metadata, relationships, and semantics. The knowledge graph 128 of information comes directly from the Instigator authoring storytelling proxies, crafting stories, creating and uploading media, mentioning keywords and topics, building whitelists and from the Interactors who interact with the storytelling proxy 122a or 122b or 122c. The knowledge graph 128 may be a database of knowledge and meaning associated with a unique storytelling proxy. The storytelling proxy's Knowledge Graph may be a collection of semantically encoded media, text, ideas and “information” that may be associated with other media and text to create the “illusion” of the storytelling proxy “being alive.”

The interactive personal storytelling proxy system 102 includes the storytelling proxy authoring module 110, the storytelling proxy conversation management module 118, and the timeline module 122. The storytelling proxy authoring module 110 may be configured to enable the Instigator to interactively create, train, test, refine and update an untrained state of storytelling proxies on the Instigator's computing device 106 by transferring the interactive content and the media content into the storytelling proxies. The Instigator may include, but not limited to, an author, a creator, and so forth. The storytelling proxy conversation management module 118 may be configured to orchestrate and synchronize different functions, and story structures into comprehensive, optimized interactive content with Interactors. The storytelling proxy authoring module 110 may be configured to allow the Instigator to share the storytelling proxies with the Interactors from the Instigator's computing device 106 thereby the semantic analysis of the storytelling proxy authoring module 110 allows the storytelling proxies get smarter through interactions from the Interactor's computing device 104 by Interactors. The Interactors may include, but not limited to, end-users, interactive users, and so forth. The timeline module 122 may be configured to distribute the storytelling proxies publicly on a home timeline after the Instigator satisfied with a trained state of the storytelling proxies.

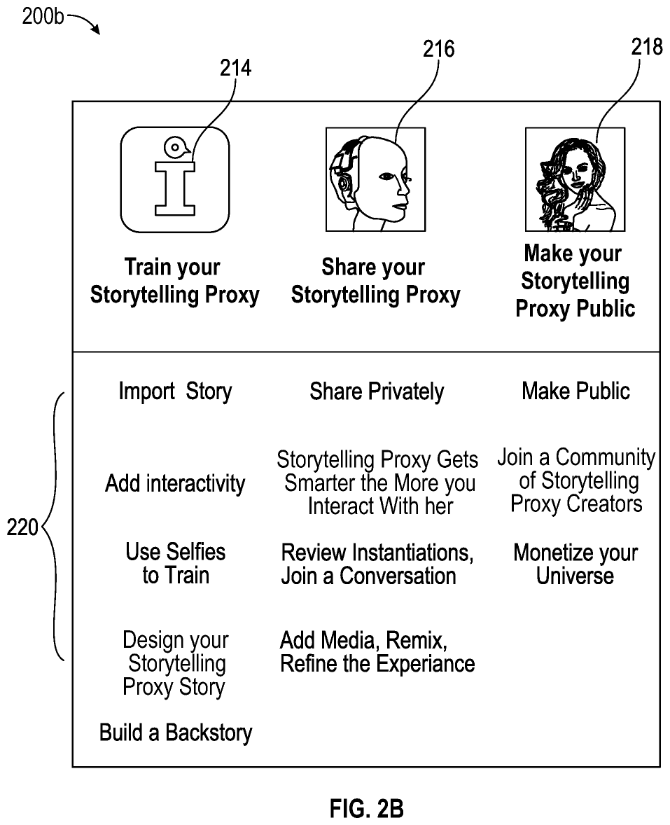

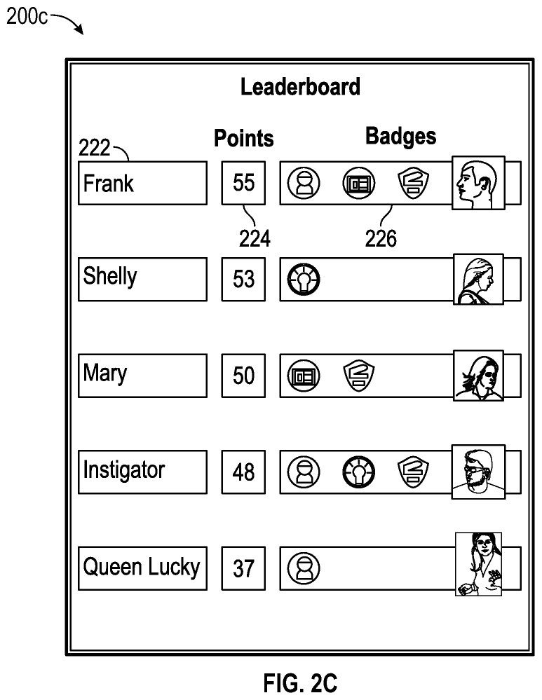

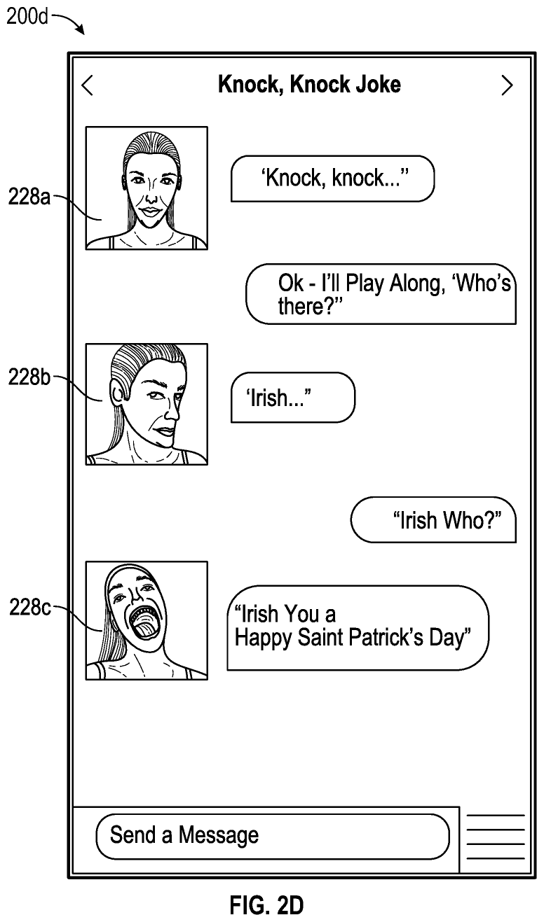

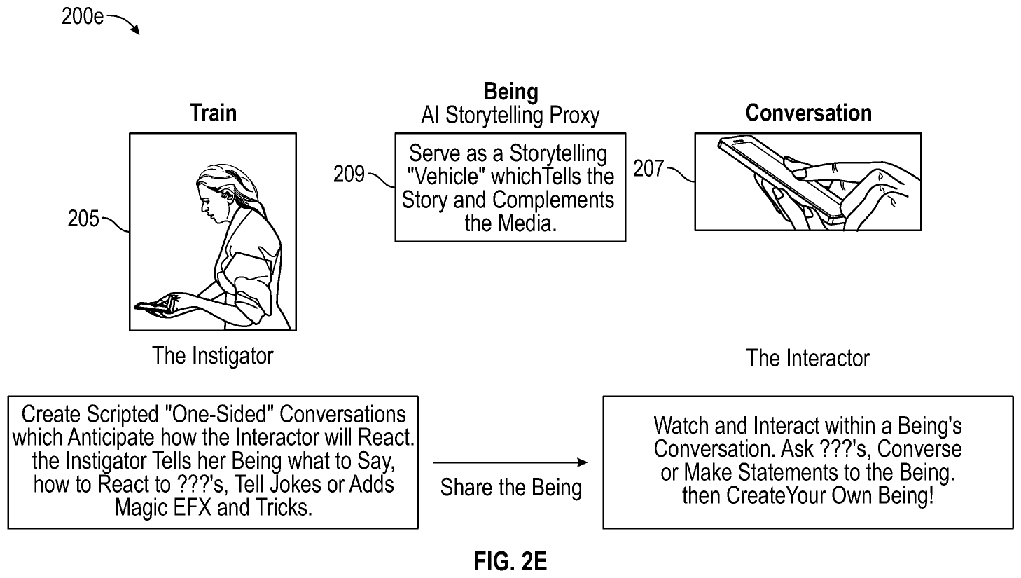

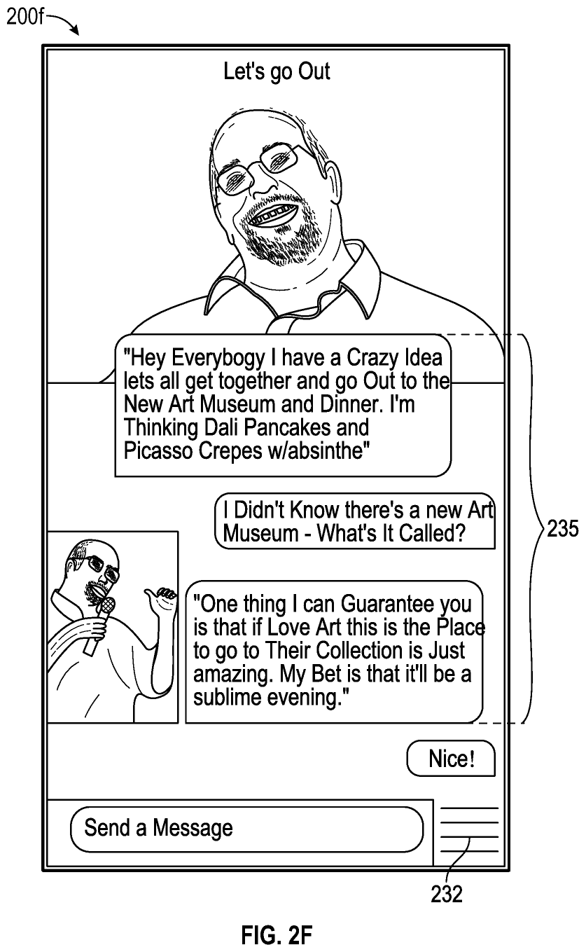

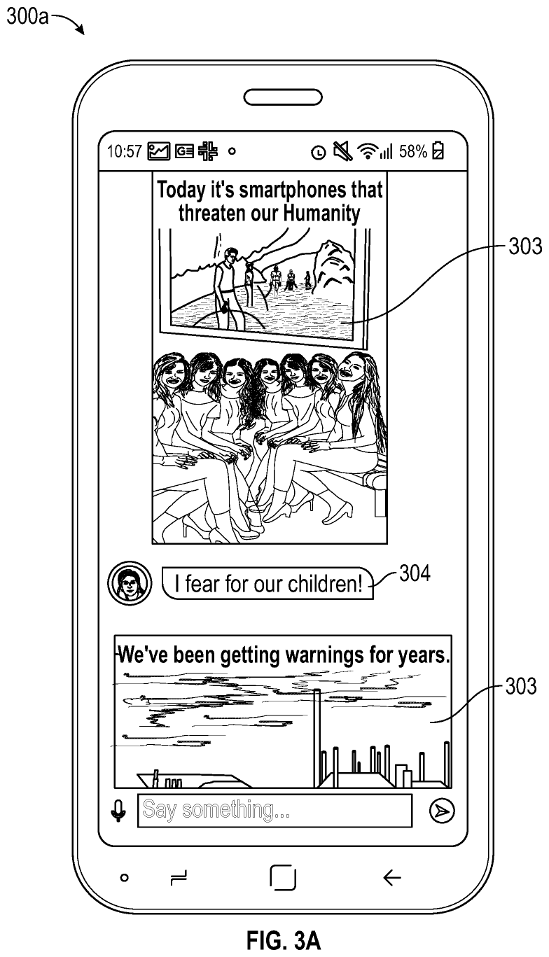

Referring to FIG. 2A, the storytelling proxy's home timeline screen 200a depicts the storytelling proxies discovered 202a, 202b, 202c, 202d, 202e, 202f, 202g, 202h, 202i as examples. These discovered storytelling proxies' home timeline may be configured to resemble similar to the home timeline of a social media platform. Furthermore, the discovered storytelling proxies' 202a, 202b, 202c, 202d, 202e, 202f, 202g, 202h, 202i may have a tile associated with name 204, an icon or image 203, and the storytelling proxy's tagline 206 describing the storytelling proxy.

The Interactor may browse the discovered storytelling proxy's timeline, tap/click on a storytelling proxy tile and immediately switch over to interact with the selected storytelling proxy. The storytelling proxy's discovery screen 200b may be configured to enable the Interactor to browse and discover other's storytelling proxies and may be associated with iconography that may also display the storytelling proxy's domain area and sharing or public setting. Furthermore, the discovered storytelling proxies' 206a-206b, for example, may have ranged in focus and type from the celebrity or brand storytelling proxies to storytelling proxies your little sister or best friend created. The discovered storytelling proxies' 206a-206b may have promotions and advertisements built into them and may access on-line libraries of media. The storytelling proxies' discovery screen 200b may be simple and the intuitive timeline may be utilized by the Interactor to navigate and discover any storytelling proxy. An initiator may simply tap/click on the storytelling proxy tile in the discover storytelling proxy timeline to load in the new storytelling proxy conversation. Here the initiator may be referred to as the Interactor who accesses the storytelling proxy for the first time.

Referring to FIG. 2B, FIG. 2B is a diagram 200d depicting a storytelling proxy's life screen, in accordance with one or more embodiments. For example, the storytelling proxy's life screen 200c depicts a train storytelling proxy 214, a share storytelling proxy 216, and a public storytelling proxy 218. The storytelling proxy's life screen 200c further depicts features 220 that happened in the different storytelling proxies. The storytelling proxy's life screen 200c not only makes for a compelling content telling architecture to the storytelling proxy's life but also provides a fundamental underlying viral nature to the product. The Instigator may train their storytelling proxy by recording video selfie clips, importing their favourite videos, stories and be designing their own stories. Adding a backstory to their train storytelling proxy 214. The train storytelling proxy 214 includes testing and iterating the content and settings of the storytelling proxy. In the storytelling proxy's early stages of the training process, it may often reach out to the Interactor pleading “please feed me some more, I need more training”. The effect of demanding more data keeps the Interactor coming back, answering more questions, defining more topics, building more content and in general, ‘training’ the storytelling proxy.

As shown in the screen 200b, the share storytelling proxy 216 may be configured to allow the Instigator to share privately with one or more Interactors. The Interactors may include, but not limited to, friends, colleagues, relatives, and so forth. By taking the storytelling proxy “seed” and exposing it to various Interactors, the interactive personal storytelling proxy system 102's machine learning identifies which paths, responses, and media are best received and interacted with. This causes the storytelling proxy to get smarter and smarter. The Instigators may review the various instantiations of the storytelling proxy and choose to join the conversation at any time. Media, archived conversations and Celeb/Brand storytelling proxy content may be remixed and “adopted” into the Instigator's storytelling proxy. The public storytelling proxy 218 may be configured to allow the Instigator to choose to take their storytelling proxy and push it public onto the interactive personal storytelling proxy system 102's public timeline. The public storytelling proxy 218 enables anyone to interact with them in their unique conversation instantiation.

Referring to FIG. 2C, FIG. 2C is a diagram 200c depicting a storytelling proxy's leaderboard screen, in accordance with one or more exemplary embodiments. The storytelling proxy's leaderboard screen 200c depicting an individual's name 222, progress points 224 and badges 226. Each individual's name 222 includes the name of the user. The leaderboard screen 200c depicting the individual's progress points 224 compared to others. The badges 226 signify specific goals completed. The Instigators know where they are in comparison to other Instigators via the leaderboard screen 200c and when they may expect to “open up” and reveal further levels of the authoring environment. The progress points 224 may be earned by tracking the Instigator's (author's) rate of training of their storytelling proxy of topics trained, of selfies recorded and overall storytelling proxy episodes created.

Referring to FIG. 2D, FIG. 2D is an example diagram 200d depicting a storytelling proxy's knock knock joke screen, in accordance with one or more exemplary embodiments. The storytelling proxy's knock joke screen 200d may be output from a language trick joke template. The storytelling proxy's knock joke screen 200d depicting a simple example of a sentence editor walking an Instigator through recording three video selfie clips 228a, 228b, 228c. The sentence provides the context within which the Instigator records its content. In an example, the Instigator may record “Knock, knock” for the first video 228a, “Irish” in the second video 228b and Irish you a happy saint patty's day in the third video 228c. The joke may be sent to the messaging interface and the interactive personal storytelling proxy system 102's storytelling proxy conversation engine 116 walks through the script, executes the story in the foreground while reacting to and handling the Interactor's text responses. The storytelling proxy's knock joke screen 200d may be inserted into the storytelling proxy's script via an insertion menu. The storytelling proxy's knock joke screen 200d may be a) an example of the output (a Conversation screengrab, b) a particular Language trick template is seen in the conversation screenshot. It is called a Language Trick. And the particular Language Trick template we see if that of a “knock, knock joke” template.

Referring to FIG. 2E, FIG. 2E is a diagram 200e depicting three-way relationship screen, in accordance with one or more exemplary embodiments. The three-way relationship screen 200e includes the Instigator 205, the artificial intelligence (AI) storytelling proxy 209, and the Interactor 207. The Instigator 205 creates script, authors story, produces media combines everything (this is how a storytelling proxy 209 is “trained”.) The Instigator 205 then tests their storytelling proxy 209 and goes back, adds some more, iterates and refines the design, tests it again and when it's ready—shares the storytelling proxy 209 privately. At some point, the storytelling proxy's Instigator may choose to push the privately shared storytelling proxy onto the Public Home timeline. The Interactor 207 receives a shared storytelling proxy 209 or discovers a storytelling proxy 209 on the Home timeline or via a standalone shared storytelling proxy 209 (from a Celeb or Brand.) This Interactor 207 interacts with the storytelling proxy 209, which is a conversational proxy for the Instigator 205. The storytelling proxy 209 is a personal storytelling proxy that “tells the story”. The storytelling proxy 209 may have backstories, and imagined soul that may be updated/refined/changed at any time, by altering its script. The Interactor 207 interacts with this storytelling proxy by typing text into the “say something.” field of the interactive personal storytelling proxy system 102.

Referring to FIG. 2N is a diagram 200n depicting let's go out screen, in accordance with one or more exemplary embodiments. The Instigator may easily move back and forth between utilizing contextually based sentences to create the storytelling proxy's content and settings and testing out the result conversation. Examples of sentence types may include, but not limited to, tell a Joke, create a diary entry and recite some Gossip and the like. The sentences may assign context to what the Instigator has already recorded on the Instigator's computing device 106 and a series of sentences allow the Instigator to construct a complex, multi-faceted type of communication. The complex, multi-faceted type of communication that may include individual statements, responses or media elements may be directly “inserted” into an episode script. Imported Instagram story may be deconstructed so that items can be inserted in between story elements. Compound sentences combine video recording with menu selection, text entry, and custom user interfaces. The let's go out screens 200n includes a reshoot selfies option, a menu option 232, and a turn into conversation option. The screen 200n further includes the number of recorded selfie videos. The screen 200n includes the filling in a sentence by recording a series of selfie videos. The sentence model strings together six different, discrete sentences all of which lead to the Instigators sending a very personalized invite out to their friends. The summary of the recorded selfie videos (sentences, e.g.,) may be utilized, so that the Instigator may go back and re-record any video during the testing process after selecting the reshoot selfies option. If the Instigator selects the turn into the conversation option, then the screen 200n may appear. The screen 200n includes the menu option 232 and conversation 235. The conversation 235 includes the sentence model which queries the Instigator to record: a) a Statement (which is the Instigator acting proactively by expressing themselves) or b) a response (which is the Instigator recording a reactive video clip-anticipating what the Interactor will say and coming up with a response to that reply ahead of time.) These gestures of proactive statements versus reactive responses reduce down to a simple set of choices that enables the Instigator to define the parameters and settings of their personalized artificial intelligence.

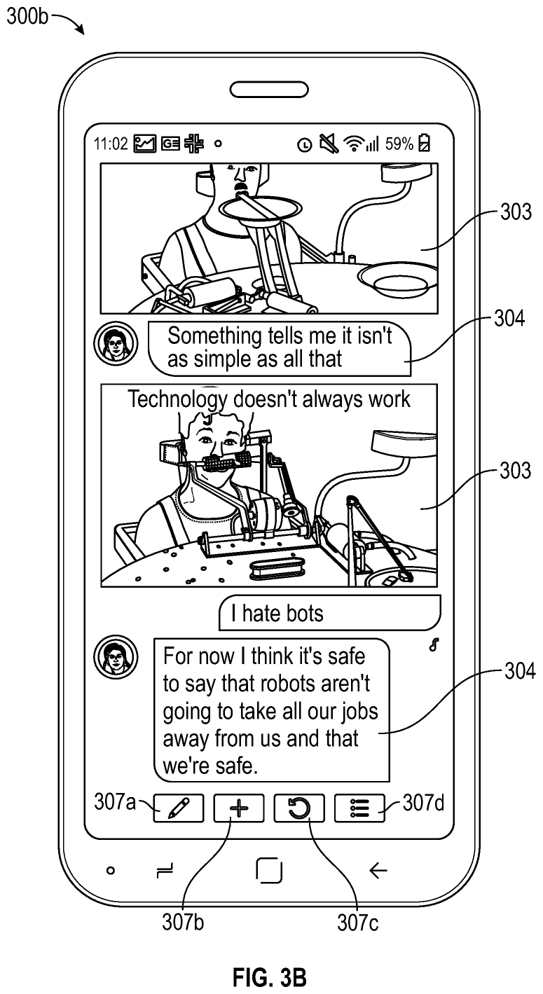

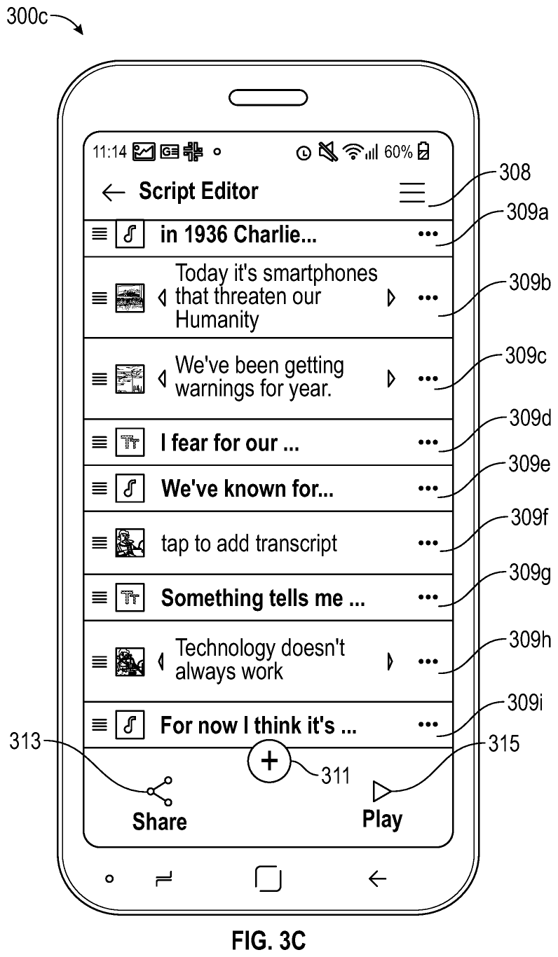

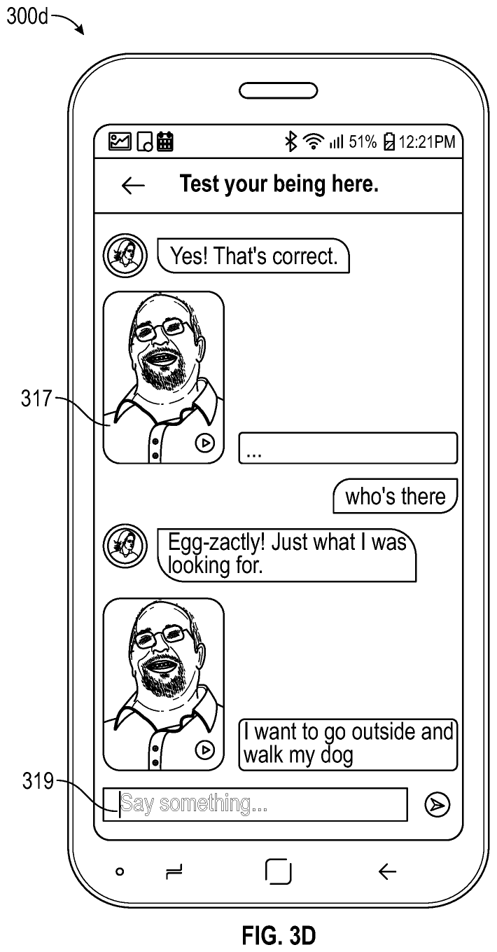

Referring to FIG. 3A-FIG. 3B, FIG. 3A-FIG. 3B are example diagrams 300a, 300b depicting an amalgam of conversational storytelling experience, memes, and interactive entertainment screens, in accordance with one or more exemplary embodiments. The conversational storytelling experience interactive entertainment screens 300a, 300b include a conversation between the storytelling proxy 303 and the Instigator 304. The conversation 303/304 may include a text which is utilized to tell a story, overlay on top of media content and as the voice of a supposed sentient storytelling proxy 303 which acts as a proxy for the Instigator. Conversational messaging is the mainstream norm of digital communication, the simple interplay may be enhanced in the interactive personal storytelling proxy system 102 with the inclusion of scripted media and a semi-autonomous storytelling proxy. The Instigators 304 weave an interactive tapestry of fun with media their storytelling proxy and then share the results with their friends. Their friends then “respond” and interact with the storytelling proxy 303 and choose to create their own storytelling proxy 303 and/or share the storytelling proxy—with someone else.

The interactive entertainment screen 300a includes a script editor option 307a, an add option 307b, a replay option 307c, and a home timeline option 307d. If the Instigator selects the script editor option 307a, then the script editor screen 300c (shown in FIG. 3D) appears on the Instigator's computing device 106. If the Instigator selects the add option 307b, then the Instigator may allow creating their storytelling proxy on the Instigator's computing device 106. If the Instigator selects the replay option 307c, then the conversation replays from initial on the Instigator's computing device 106. If the Instigator selects the home timeline option 307d, then the home timeline screen 200a (shown in FIG. 2A) appears on the Instigator's computing device 106.

Referring to FIG. 3C, FIG. 3C is a diagram 300c depicting a script editor screen, in one or more exemplary embodiments. The script editor screen 300d includes a menu option 308, scripts 309a, 309b, 309c, 309d, 309e, 309f, 309g, 309h, 309i, a plus sign option 311, a share option 313, and a play option 315. The script edit screen 300c on the Instigator's computing device 106 may be configured to enable the Instigator to create, edit and update the scripts 309a, 309b, 309c, 309d, 309e, 309f, 309g, 309h, 309i. The scripts 309a, 309b, 309c, 309d, 309e, 309f, 309g, 309h, 309i may belong to storytelling proxy scripts. Every storytelling proxy has an associated script that controls all of the details, aspects, and characteristics of the storytelling proxy's conversational experience. Those details may be defined by the storytelling proxy's script and created and edited in the script editor. The script 309a or 309b or 309c or 309d or 309e or 309f or 309g or 309h or 309i may be made up of script elements, typed by media, narration/text, and background, magic EFX, language trick. Also, a “special script element” called a whitelist may also be inserted into the storytelling proxy's script.

The authoring/creation process of an instigate storytelling proxy entails tapping on the “Plus+” sign option 311, which opens up an “Insertion Menu” of insertion choices. Once an insertion type has been selected (such as media or interactive content) the Instigator is displayed the appropriate “screen” to facilitate either recording or uploading a media element or typing text on the Instigator's computing device 106. This new element may be added to the storytelling proxy's script 309a or 309b or 309c or 309d or 309e or 309f or 309g or 309h, at the bottom of the script. If the storytelling proxy is JUST being created, this first element may go into the first slot in the storytelling proxy's script. Subsequent elements may be added to the first element. The Instigator repeats the process of tapping on the plus “+” sign option 311, choosing the insertion type and then creating/uploading the media content. Special Insertion types are utilized to facilitate: whitelists, background, magic effect, language tricks Knock, knock, Let's go out, Media Menu, and so forth. Whitelists are a list of keywords or phrases (with associated triggered content) that may be tied to what the storytelling proxy's “participant” types into the text input field. If a keyword is typed, then the associated text or media element may be displayed on the Instigator's computing device 106. Background—this is a background audio file that may commence playing when this script element is executed as part of the storytelling proxy's conversation. Magic Effect is when a unique video (either recorded or uploaded) is associated with a whitelist so that special text or media is triggered once a whitelist keyword is uttered on the audio track of the video. Language tricks may include “templates” of scripted interaction between the storytelling proxy and the storytelling proxy conversation participant. Tricks are available in this prototype such as Knock, knock—which plays out the classic “knock, knock” joke sequence, Let's go out—which creates an eVite structure, which unique whitelists for each stage. Media Menu—which quickly establishes a set of Media Questions and responses.

Once the script is edited, it is “Played back” by tapping on the play button 315. At that point, the Instigator turns into the conversation participant to test out the current storytelling proxy as shown in FIG. 3D. The script editor screen 300c includes compelling conversational storytelling experiences, a directory of pre-built and public storytelling proxies, a tool for creating and editing a storytelling proxy, a mechanism for privately sharing storytelling proxy with others, an AI-based ‘wrapper” layer provides notification, tutorial and intro videos, underlying machine learning code which “makes a storytelling proxy smarter”—over time. An “About” screen communicates basic information about the company and product and provides “access” to settings screens.

Referring to FIG. 3D, FIG. 3D is an example diagram 300d depicting the multi-media chat messaging screen, in accordance with one or more exemplary embodiments. The multi-media chat messaging screen 300d may be the storytelling proxy testing screen. The Instigator or the Interactor 317 in the storytelling proxy conversation in one of two ways: Instigator or the Interactor may respond by typing text into a text input field 319 and they may tap on the amber circle and move onto the next script element in the conversation. At any time, the Instigator or the Interactor 317 may do either option. The Interactor and the Instigator 317 may type anything into the text field 319 at any time or they may choose to stop the video and move onto the next script element. Once a storytelling proxy's conversation plays the final element in the script, the “final menu” appears signifying that the conversation “is over.” That final menu displays four options: go into edit mode, create a new storytelling proxy, playback this current storytelling proxy—again go to my list of storytelling proxy—that the Instigator has created (called My Meme Beings). The process of creating the storytelling proxy (inside the Script editor), playing back and interacting with that storytelling proxy (in the storytelling proxy conversation) and going back into edit mode to refine/edit/change/add to the storytelling proxy—repeats itself over and over again. Once the Instigator is satisfied with their storytelling proxy, it is then time for them to share the storytelling with any user. The user may include, but not limited to, a friend, colleague or family member, a neighbor, and the like. When the storytelling proxy is shared, the participant role is now executed by the storytelling proxy's Sharee.

An Instigate storytelling proxy is a scripted one-sided conversation where the Instigator “anticipates” how the Interactor may react and respond to various statements, questions, storylines—put forth by the storytelling proxy and her accompanying media elements. The Instigator crafts a script, which sequences photos, video and sound/music to tell a story and enhances that story by building in text and media responses that provide interactive possibilities in the narrative. Storyline branches, questions and answers and “sentient personality” are all possibilities within interactive personal storytelling proxy system 102.

The story unfolds vertically inside of a conversational interface, with participants choosing to either directly reply (via text) to any story element in the conversation or step forward to the next element in the Story. The result is a new kind of interactive narrative that picks up where Instagram stories—leave off. A three-way relationship may be established as the Instigator builds the script (which is made up of the storytelling proxy's text, media playback, and special EFX) on the Instigator's computing device 106 and then privately “shares” that storytelling proxy with a friend, family member or colleague. The conversation “sharee” converses with the “supposed storytelling proxy” and the uncanny Valley may be given the finger—as we all know there's a (wo)man standing behind the curtain—pulling levers and turning knobs. The interactive personal storytelling proxy system 102 enables anyone to become their own Geppetto, forging interactive media Pinocchios that trigger viral uptake.

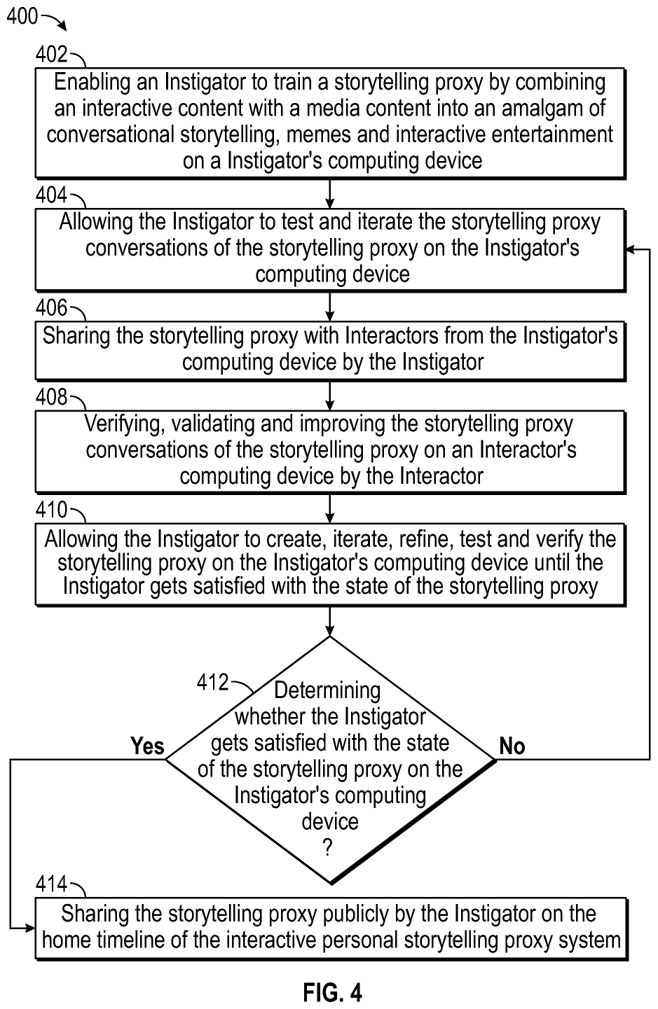

Referring to FIG. 4, FIG. 4 is a flow diagram 400 depicting a method for training the storytelling proxy to share on the public domain timeline, in one or more exemplary embodiments. The method 400 may be carried out in the context of the details of FIG. 1A-FIG. 1B and FIG. 2A-FIG. 2C. However, method 400 may also be carried out in any desired environment, and it is pertinent to note that not all steps are mandatory or need to be performed in the same fashion (i.e., there is no implication of linearity in steps). Further, the aforementioned definitions may equally apply to the description below.

The method commences at step 402 by enabling the Instigator to train the storytelling proxy by combining the interactive content with the media content into an amalgam of conversational storytelling, memes and interactive entertainment on the Instigator's computing device. The media content may include, but not limited to, videos, images, language special EFX, and so forth. Thereafter, at step 404, allowing the Instigator to test and iterate the storytelling proxy conversations of the storytelling proxy on the Instigator's computing device. Thereafter, at step 406, sharing the storytelling proxy with the Interactors from the Instigator's computing device by the Instigator. Thereafter, at step 408, verifying, validating and improving the storytelling proxy conversations of the storytelling proxy on the Interactor's computing device by the Interactor. Thereafter, at step 410, allowing the Instigator to create, iterate, refine, test and verify the storytelling proxy on the Instigator's computing device until the Instigator gets satisfied with the state of the storytelling proxy. Thereafter, at step 412, determining whether the Instigator gets satisfied with the state of the storytelling proxy on the Instigator's computing device? If the answer to step 412 is YES, then the method continues at step 414, sharing the storytelling proxy publicly by the Instigator on the home timeline of the interactive personal storytelling proxy system. If the answer to step 412 is NO, then the method continues at step 416, the method continues at step 404.

The method commences at step 302 by creating the video selfie created by the Instigator. The Instigator may be enabled to view the transcription of the captured video, at step 304. The Instigator selects which meta-data may be utilized to represent the meaning and content of the video, at step 306. The Instigator's video may be coupled together to create a “Magic EFX” effect, at step 308. The metadata of each video selfie recorded by the Instigator may be shared with a storytelling proxy conversation engine, at step 310. The Instigator may respond to questions and answers regarding the created video, at step 312. The Instigator may create a backstory item, at step 314. Here, the backstory may be referred to as storytelling proxy's life. The created backstory item may be provided as an input to the storytelling proxy conversation engine, at step 316. The Instigator may be allowed to produce a storytelling proxy, which is configured to interact with the Interactors, at step 318. The storytelling proxy may be allowed to be shared by the Instigator, at step 320.

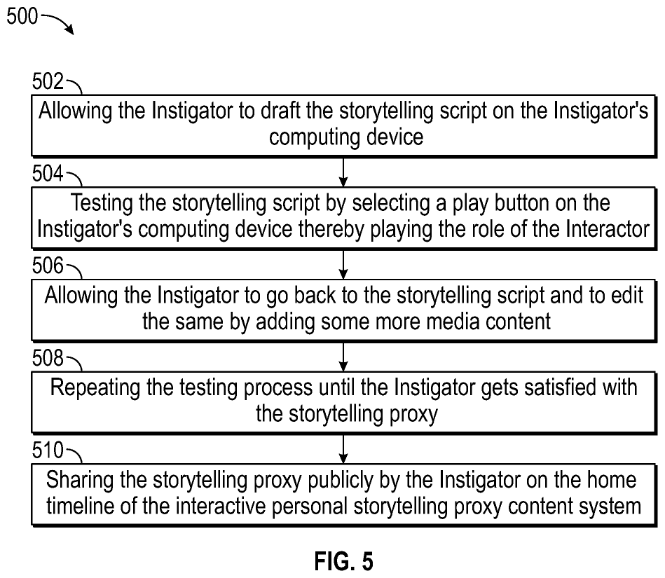

Referring to FIG. 5, FIG. 5 is a flow diagram 500 depicting a method for improving storytelling script of the storytelling proxy, in one or more exemplary embodiments. The method 500 may be carried out in the context of the details of FIG. 1A-FIG. 1B and FIG. 2A-FIG. 2C. However, method 500 may also be carried out in any desired environment, and it is pertinent to note that not all steps are mandatory or need to be performed in the same fashion (i.e., there is no implication of linearity in steps). Further, the aforementioned definitions may equally apply to the description below.

At step 502, allowing the Instigator to draft the storytelling script on the Instigator's computing device. Thereafter, at step 504, testing the storytelling script by selecting the play button on the Instigator's computing device thereby playing the role of the Interactor. Thereafter, at step 506, allowing the Instigator to go back to the storytelling script and to edit the same by adding some more media content. Thereafter, at step 508, repeating the testing process until the Instigator gets satisfied with the storytelling proxy. Thereafter, at step 510, sharing the storytelling proxy publicly by the Instigator on the home timeline of the interactive personal storytelling proxy system.

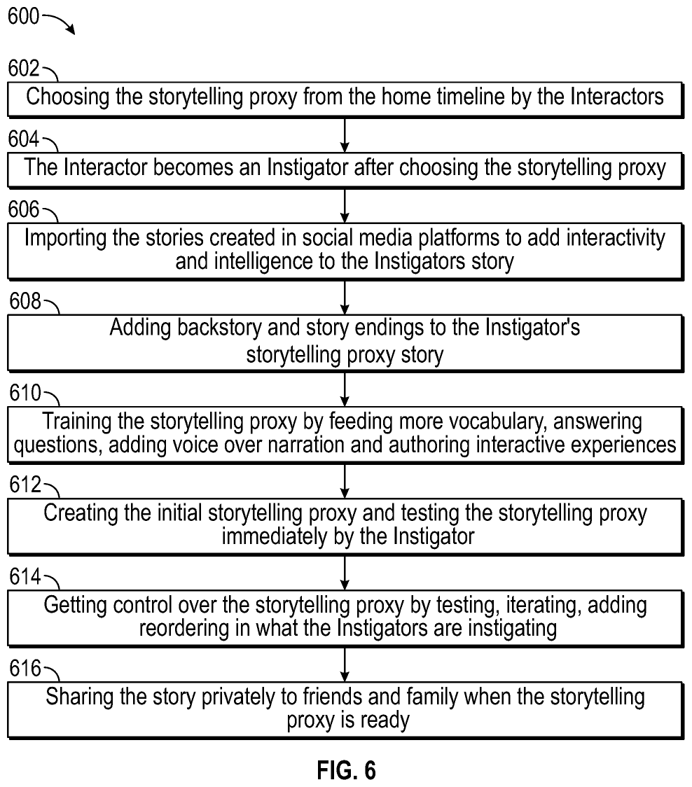

Referring to FIG. 6, FIG. 6 is a flow diagram 600 depicting a method for developing and sharing storytelling proxy by the Instigators, in one or more exemplary embodiments. The method 600 may be carried out in the context of the details of FIG. 1A-FIG. 1B and FIG. 2A-FIG. 2C, FIG. 3A, FIG. 3B, FIG. 3C, FIG. 3D, FIG. 4, FIG. 5. However, method 600 may also be carried out in any desired environment, and it is pertinent to note that not all steps are mandatory or need to be performed in the same fashion (i.e., there is no implication of linearity in steps). Further, the aforementioned definitions may equally apply to the description below.

At step 602, choosing the storytelling proxy by the adventurous Interactors. Thereafter, at step 604, the Interactor becomes an Instigator after choosing the storytelling proxy. Thereafter, at step 606, importing the stories created in social media platforms to add interactivity and intelligence to the Instigators story. Thereafter, at step 608, adding backstory and story endings to the Instigator's storytelling proxy story. Thereafter, at step 610, training the storytelling proxy by feeding more vocabulary, answering questions, adding voice over narration and authoring interactive experiences. Thereafter, at step 612, creating the initial storytelling proxy and testing the storytelling proxy immediately by the Instigator. Thereafter, at step 614, getting control over the storytelling proxy by testing, iterating, adding, reordering in what the Instigators are instigating. Thereafter, at step 616, sharing the story privately to friends and family when the storytelling proxy is ready.

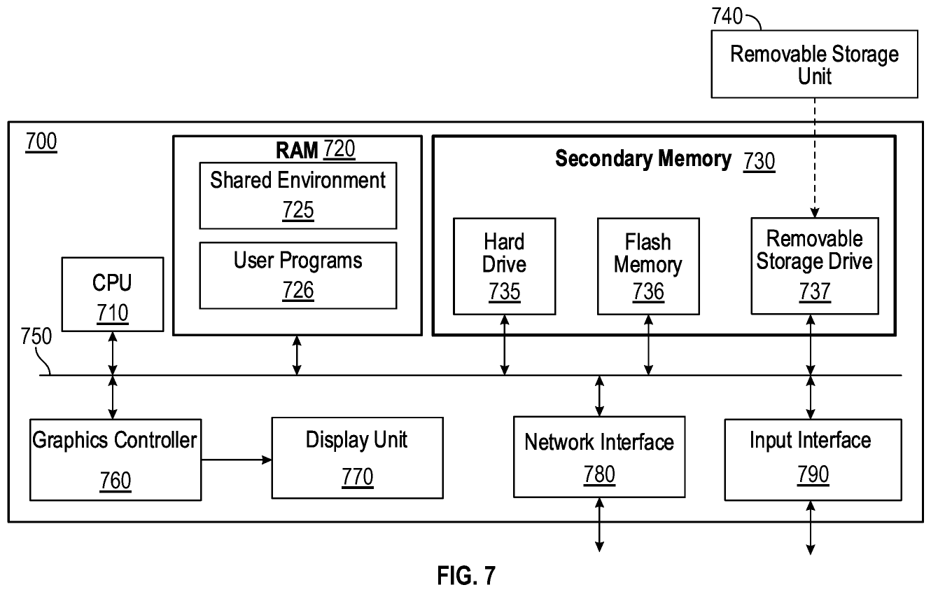

Referring to FIG. 7, FIG. 7 is a block diagram 700 illustrating the details of a digital processing system 700 in which various aspects of the present disclosure are operative by execution of appropriate software instructions. The Digital processing system 700 may correspond to computing devices 104-106 (or any other system in which the various features disclosed above can be implemented).

Digital processing system 700 may contain one or more processors such as a central processing unit (CPU) 710, random access memory (RAM) 720, secondary memory 727, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions, such as those used in threads and stacks, constituting shared environment 725 and/or user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems (such as those shown in FIG. 1, network 108) connected to the network.

Secondary memory 730 may contain hard drive 735, flash memory 736, and removable storage drive 737. Secondary memory 730 may store the data software instructions (e.g., for performing the actions noted above with respect to the Figures), which enable digital processing system 700 to provide several features in accordance with the present disclosure.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EEPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., nonremovable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Nonvolatile media includes, for example, optical disks, magnetic disks, or solid-state drives, such as storage memory 730. Volatile media includes dynamic memory, such as RAM 730. Common forms of storage media include, for example, a floppy disk, a flexible disk, hard disk, solid-state drive, magnetic tape, or any other magnetic data storage medium, a CDROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infrared data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Amendments and edits to the above-referenced disclosure is made via the Annexure herein. The disclosure set out in the Annexure hereto forms an integral part of this Specification and in the event of any conflict or discrepancy between the disclosure in the Specification and in the Annexure, the disclosure in the Annexure shall prevail.

What is claimed is:

1. A topic based artificial intelligence authoring and playback system, comprising:
an interactive personal storytelling proxy system comprising a storytelling proxy authoring module, a storytelling proxy conversation management module, and a timeline module,
wherein the storytelling proxy authoring module configured to enable an Instigator to interactively create, train, test, refine and update an untrained state of a plurality of storytelling proxies on an Instigator's computing device by transferring an interactive content and a media content into the plurality of storytelling proxies, the storytelling proxy conversation management module configured to orchestrate and synchronize different functions, and story structures into comprehensive, optimized interactive content with a plurality of Interactors, the storytelling proxy authoring module configured to allow the Instigator to share the plurality of storytelling proxies with the plurality of Interactors from the Instigator's computing device thereby a semantic analysis of the storytelling proxy authoring module allows the plurality of storytelling proxies gets smarter through a plurality of interactions from an Interactor's computing device by a plurality Interactors, the timeline module configured to distribute the plurality of storytelling proxies publicly on a home timeline after the Instigator satisfied with a trained state of the plurality of storytelling proxies.

2. The artificial intelligence authoring and playback system of claim 1, wherein the storytelling proxy conversation management module comprising a script editor module configured to enable the Instigator to create, edit and update a plurality scripts associated with the plurality of storytelling proxies.

3. The artificial intelligence authoring and playback system of claim 2, wherein the script editor module is configured to allow the Instigator to open up the plurality of scripts, select a plurality of script elements, copy the plurality of script elements onto a clipboard of a storytelling proxy.

4. The artificial intelligence authoring and playback system of claim 3, wherein the plurality of script elements comprising the media content, narration, background, magic motion picture special effects, language tricks, and also a plurality of whitelists.

5. The artificial intelligence authoring and playback system of claim 1, wherein the storytelling proxy conversation management module comprising a knowledge graph of information comes directly from the plurality of storytelling proxies, crafting stories, creating and uploading media, mentioning keywords and topics, building whitelists and the plurality of interactions from the Interactors who interact with the plurality of storytelling proxies.

6. The artificial intelligence authoring and playback system of claim 1, wherein the storytelling proxy conversation management module comprising a storytelling proxy share module configured to enable the Instigator on the Instigator's computing device to send an invite to a plurality of end-users to become the plurality of Interactors of the plurality of storytelling proxies.

7. The artificial intelligence authoring and playback system of claim 1, wherein the storytelling proxy conversation management module comprising a plurality of agents configured to guide the Instigator by triggering a plurality of instructional notifications and a plurality of instructional alerts on the Instigator's computing device.

8. The artificial intelligence authoring and playback system of claim 7, wherein the plurality of agents is configured to provide a controlled environment to the Instigator on the Instigator's computing device.

9. The artificial intelligence authoring and playback system of claim 7, wherein the plurality of agents comprising encapsulated experiences to:
import a story on social networking service, create a backstory item, and utilize the media content in new ways and help the Instigator.

10. A method for distributing storytelling proxy on a public domain timeline, comprising:
creating, training, testing, refining and updating an untrained state of a plurality of storytelling proxies on an interactive personal storytelling proxy system by transferring an interactive content and a media content into the plurality of storytelling proxies from an Instigator's computing device;
sharing the plurality of storytelling proxies with a plurality of Interactors from the Instigator's computing device by the Instigator, whereby the plurality of Interactors interacts with the plurality of storytelling proxies on an Interactor's computing device thereby the plurality of storytelling proxies gets smarter by a semantic analysis of the interactive personal storytelling proxy system through a plurality of interactions from the Interactor's computing device by the plurality Interactors;
allowing the Instigator to test and iterate a plurality of storytelling proxy conversations of the plurality of storytelling proxies on the Instigator's computing device until the Instigator gets satisfied with a trained state of the plurality of storytelling proxies; and
distributing the plurality of storytelling proxies publicly on a home timeline of the interactive personal storytelling proxy system by the Instigator from the Instigator's computing device after the Instigator satisfied with a state of the plurality of storytelling proxies.

11. The method of claim 10, further comprising a step of creating a plurality of storytelling scripts associated with the plurality of storytelling proxies by the Instigator on the Instigator's computing device.

12. The method of claim 10, further comprising a step of testing the plurality of storytelling scripts by selecting a play button of the interactive personal storytelling proxy system on the Instigator's computing device thereby playing a role of the Interactor by the Instigator.

13. The method of claim 10, further comprising a step of editing the plurality of storytelling scripts by adding the media content and the interactive content to the plurality of storytelling scripts by the Instigator.

14. The method of claim 10, further comprising a step of choosing the plurality of storytelling proxies by importing a plurality of stories created in social media platforms and adding backstories and story endings to the plurality of storytelling proxies by the plurality of Interactors and become a plurality of Instigators on the Interactor's computing device.

15. The method of claim 14, further comprising a step of training the plurality of storytelling proxies by feeding more vocabulary, answering questions, adding voice over narration and authoring interactive experiences.

16. A computer program product comprising a non-transitory computer-readable medium having a computer-readable program code embodied therein to be executed by one or more processors, said program code including instructions to:
create, train, test, refine and update an untrained state of a plurality of storytelling proxies of an interactive personal storytelling proxy system by transferring an interactive content and a media content into the plurality of storytelling proxies on an Instigator's computing device;
share the plurality of storytelling proxies with a plurality of Interactors from the Instigator's computing device by the Instigator, whereby the plurality of Interactors interacts with the plurality of storytelling proxies on an Interactor's computing device thereby the plurality of storytelling proxies gets smarter by a semantic analysis through a plurality of interactions from the Interactor's computing device by the plurality Interactors;
allow the Instigator to test and iterate a plurality of storytelling proxy conversations of the plurality of storytelling proxies on the Instigator's computing device until the Instigator gets satisfied with a state of the plurality of storytelling proxies; and
distribute the plurality of storytelling proxies publicly on a home timeline of an interactive personal storytelling proxy system by the Instigator from the Instigator's computing device after the Instigator satisfied with a trained state of the plurality of storytelling proxies.
